(19) United States
(12) Patent Application Publication
(10) Pub. No.: US 2016/0208497 A1
(43) Pub. Date: Jul. 21, 2016

(54) COMBINATION FRAME MATERIAL

(71) Applicant: CHENG-HUNG YANG, Taichung City (TW)

(72) Inventor: CHENG-HUNG YANG, Taichung City (TW)

(21) Appl. No.: 14/951,363

(22) Filed: Nov. 24, 2015

Related U.S. Application Data
(63) Continuation-in-part of application No. 14/601,163, filed on Jan. 20, 2015, now abandoned.

(51) Int. Cl. E04F 13/08; E04F 13/18; B32B 7/08; E04F 13/072; B32B 3/06; B32B 3/30

(52) U.S. Cl. CPC E04F 13/0801; B32B 3/06; B32B 3/30; B32B 7/08; E04F 13/072; E04F 13/18; B32B 2451/00; B32B 2419/00

(57) ABSTRACT

A combination frame material comprises an outer frame and an inner frame. The outer frame has an outer side and an inner side, with the inner side provided with two parallel combining grooves with a middle pillar disposed therebetween for dividing the two combining grooves. The inner frame has two parallel combining parts for being transversely received in the two combining grooves, with a pillar groove disposed between the two combining parts for receiving the middle pillar. Thus, the outer frame and the inner frame are allowed to be combined easily and efficiently.

### BACKGROUND OF THE INVENTION

1. Field of the Invention

The present invention relates to frame materials, and more particularly, to a combination frame material which is easily assembled.

2. Description of the Related Art

A known composite frame material in the market comprises a plastic-wood outer frame with an aluminum extrusion inner frame embedded therein, which is applied on constructional decoration such as window frames, handrails, or pillars, such that constructional elements of single wood or metal material is substituted thereby.

However, said plastic-wood outer frame and aluminum extrusion inner frame are combined to each other in opposite direction. In other words, the opening of the plastic-wood outer frame faces the opening of the aluminum extrusion inner frame in the combination. As a result, during the embedding process, operator shall carefully and accurately match the openings of these two components, so as to fit the aluminum extrusion inner frame in the opening of the plastic-wood outer frame. Especially, due to the material characteristics of the aluminum extrusion inner frame, the opening tends to expand open, thereby hindering the installation process and lowering the efficiency of the combining operation.

Furthermore, if the surface-to-be-treated is not flat or is biased, the combination of the outer frame and the inner frame is prevented from being flat as well, thus affecting the general appearance and failing to meet the user expectation.

### SUMMARY OF THE INVENTION

For improving abovementioned issues, the present invention discloses a combination frame material, wherein the outer frame is transversely combined with the inner frame, and the interval between the outer frame and the inner frame is allowed to be adjusted, facilitating the installation of the combination frame material upon an irregular surface. The structure of the combination frame material is stable and easily assembled.

For achieving abovementioned objectives, the present invention provides a combination frame material, comprising:

an inner frame formed of an aluminum extrusion and axially provided with two parallel combining parts, a pillar groove disposed between the two combining parts and dividing the two combining parts, each of the combining parts having an outer wall, an inner wall, and a flat wall connected between the outer wall and the inner wall, the two inner walls disposed on two sides of the inner side of the pillar groove, a slope wall inclinedly disposed in an angle between the flat wall and the outer wall and between the flat wall and the inner wall, respectively, each of the outer walls longitudinally provided with plural hook portions, each of the hook portions extending along an axial direction of the inner frame; and

an outer frame formed of plastic-wood material and having an outer side and an inner side, the inner side having two combining grooves and a middle pillar disposed between the two combining grooves, the middle pillar dividing the two combining grooves, an inside wall of each combining groove opposite to the middle pillar having plural hook grooves, such that the outer frame is transversely combined with the inner frame, the middle pillar is inserted in the pillar groove, the two combining parts are combined in the two combining grooves, and the hook grooves are coupled with the hook portions.

With such configuration, the outer frame is transversely combined with the inner frame. With the hook grooves coupled with the hook portions, the interval between the outer frame and the inner frame is adjusted, such that the combination frame material provided by the present invention is able to be applied on an irregular surface-to-be-treated. The outer frame and the inner frame are provided with greater positioning effect against each other, and the convenience of assembling is achieved.

### BRIEF DESCRIPTION OF THE DRAWINGS

FIG. 1 is a perspective view of the combination frame material in accordance with the present invention.

FIG. 2 is an exploded view of the combination frame material in accordance with the present invention.

FIG. 3 is another exploded view of the combination frame material in accordance with the present invention.

FIG. 4 is a side view of the combination frame material in accordance with the present invention.

FIG. 5 is another side view illustrating another combination status of the combination frame material in accordance with the present invention.

FIG. 6 is a schematic view illustrating the status of the present invention applied on a floor.

FIG. 7 is a schematic view illustrating another embodiment of the present invention.

FIG. 8 is a schematic view illustrating the status of the present invention applied on a wall.

FIG. 9 is a schematic view illustrating the status of the present invention applied as a standing pillar.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

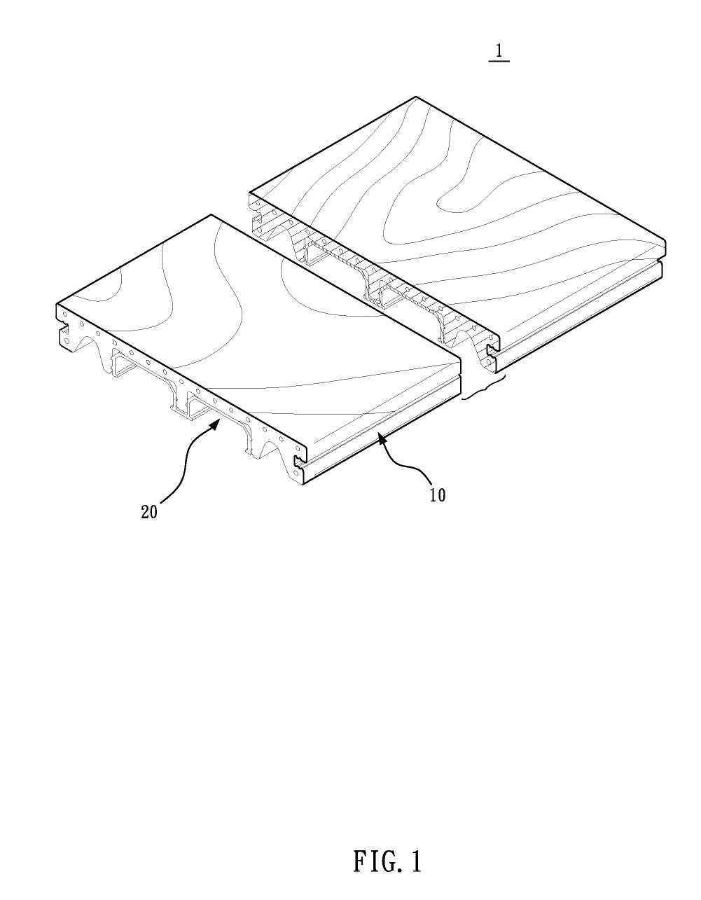

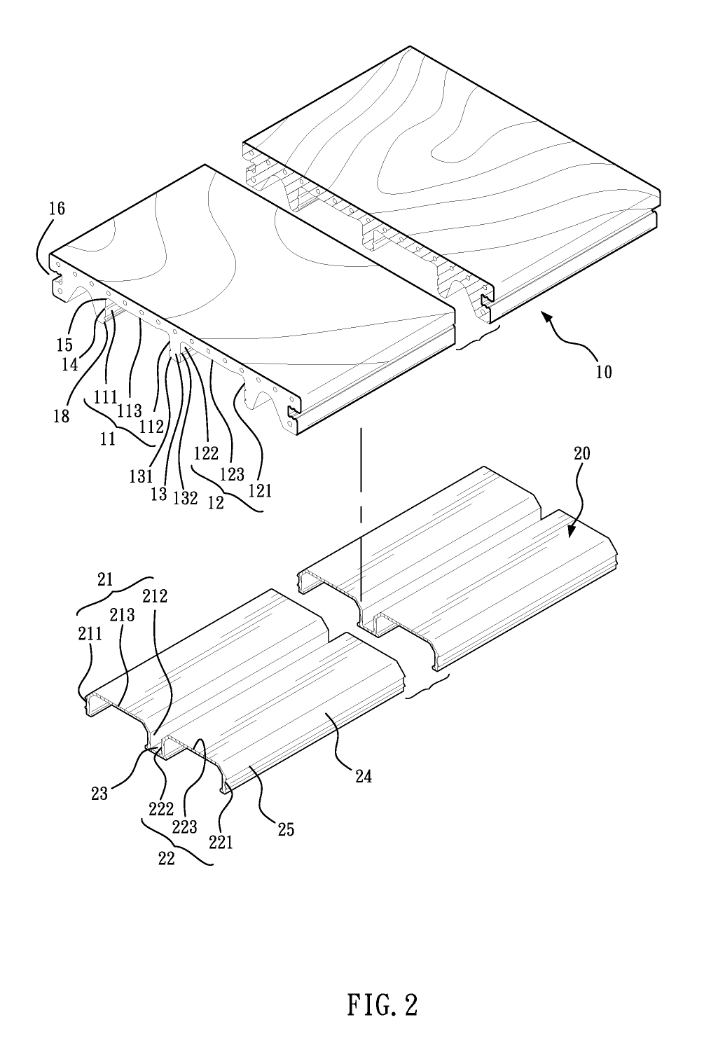

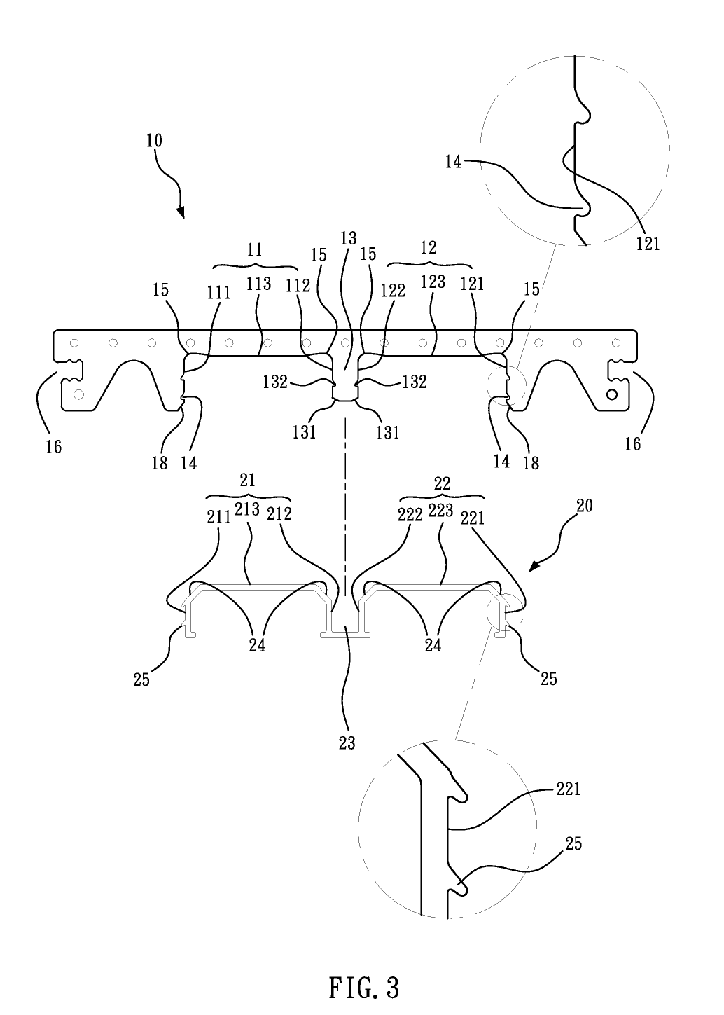

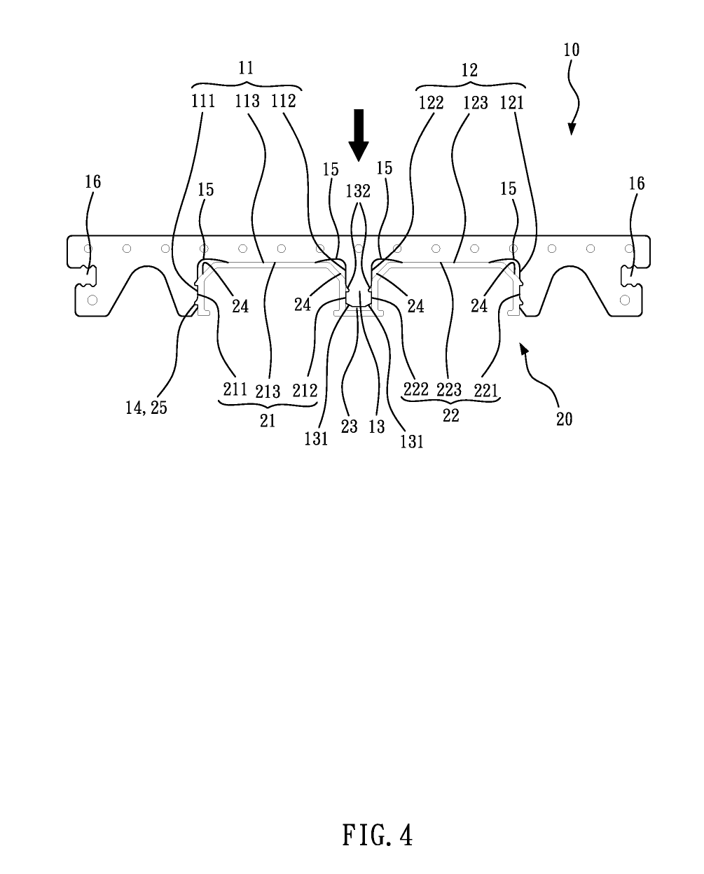

Referring to FIG. 1 to FIG. 4, a combination frame material 1 provided by the present invention comprises an outer frame 10 and an inner frame 20.

The outer frame 10 is made of plastic-wood material in strip shape. The raw material of the outer frame 10 is an extrusion of a mixture mainly comprising thermoplastic and natural fiber (such as wood powder, rice hull, wheat straw, and bamboo powder).

The outer frame 10 has an outer side and an inner side, while the outer side is provided with a wood-like pattern, and the inner side is concavely provided with two parallel combining grooves 11, 12 with a middle pillar 13 therebetween for dividing the two combining grooves 11, 12. The combining grooves 11, 12 are provided with an inside wall 111, 121 and another inside wall 112, 122 oppositely disposed against the inside wall 111, 121, respectively. The two inside walls 111, 121 are provided with plural hook grooves 14, respectively, wherein the inner end of each hook groove 14 is formed in a circular shape. In the preferred embodiment of the present invention, the inside walls 111, 121 have two hook grooves 14, respectively, but the number of the hook grooves 14 is not limited in two in the scope of the present invention.

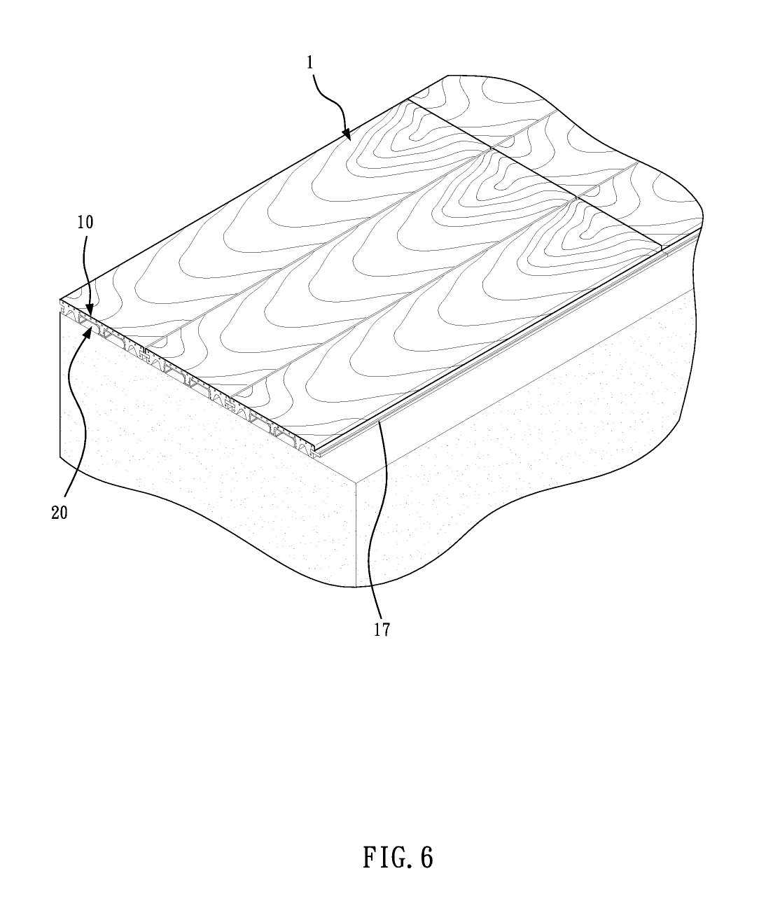

The combining grooves 11, 12 further have a bottom wall 113, 123, respectively, while two sides of the two bottom walls 113, 123 are provided with a corner recess 15, respectively, which is formed in a concave-arc shape, thereby preventing the outer frame 10 to deform when exposed to heat. Furthermore, two sides of the outer frame 10 are provided with a connect groove 16, respectively. A connector 17 (as shown in FIG. 6) is able to be received in the connect groove 16, so as to connect another outer frame 10.

Further, the outer frame 10 has a bevel 18 disposed on the inside wall 111, 121 opposite to the middle pillar 13, respectively. Especially, the length of the middle pillar 13 is smaller than the length of the inside wall 111, 121. Also, a slope edge 131 is disposed on two sides of an end part of the middle pillar 13, respectively, and the two sides of the middle pillar 13 are provided with a coupling groove 132, respectively.

The inner frame 20 is made of an aluminum extrusion strip, having two parallel combining parts 21, 22 for being received in the two combining grooves 11, 12 of the outer frame 10. The two combining parts 21, 22 are formed in a hollow shape. A pillar groove 23 is disposed between the two combining parts 21, 22 for dividing the two combining parts 21, 22. Each of the combining parts 21, 22 is provided with an outer wall 211, 221, an inner wall 212, 222, and a flat wall 213, 223 connected between the outer wall 211, 221 and the inner wall 212, 222, respectively. The two inner walls 212, 222 are disposed on two sides of the inner edge of the pillar groove 23. Furthermore, a slope wall 24 is inclinedly disposed in an angle between the flat wall 213, 223 and the outer wall 211, 221 and between the flat wall 213, 223 and the inner wall 212, 222, respectively. The slope wall 24 is inclinedly disposed in an angle between 30 to 45 degrees against the flat wall 213, 223. The length of the bevel 18 of the outer frame 10 is smaller than the length of the slope wall 24; also, the length of the slope edge 131 of the outer frame 10 is smaller than the length of the slope wall 24. Each outer wall 211, 221 is longitudinally provided with plural hook portions 25, respectively, wherein the amount and the shape of the hook portions 25 are identically matched with the amount and the shape of the corresponding hook grooves 14. Furthermore, each hook portion 25 extends along an axial direction of the inner frame 20. Each hook portion 25 is inclinedly disposed toward each corresponding outer wall 211, 221 in an angle between 30 to 45 degrees. At least one of the hook portions 25 on each outer wall 211, 221 neighbors with the corresponding slope wall 24. Especially, an end part of each hook portion 25 is formed in a circular shape.

Furthermore, the outer frame 10 is transversely combined to the inner frame 20, such that the middle pillar 13 is inserted in the pillar groove 23, the two combining part 21, 22 are combined to the two combining groove 11, 12, and the hook grooves 14 are coupled with the hook portions 25. Therefore, when the outer frame 10 bears an external force, the middle pillar 13 is able to disperse the external force for achieving a better support effort, so that the outer frame 10 is prevented from deform due to force bearing, thus providing a higher structural strength to the combination frame material 1 of the present invention.

Also, the openings of the inner frame 20 and the outer frame 10 face the same direction, facilitating the combining process of the inner frame 20 and the outer frame 10. When the combination between the inner frame 20 and the outer frame 10 is completed, the corner recesses 15 overlap the corresponding slope walls 24, provided a greater positioning effect and an easy assembling advantage.

During the combination, the inner frame 20 is allowed to be fixed on the floors, walls, or other surfaces-to-be-treated in advance by use of fasteners (not shown in the drawings), with the combining parts 21, 22 thereof facing outward. Next, the outer frame 10, with the combining grooves 11, 12 respectively facing the combining parts 21, 22, is transversely tapped to couple the inner frame 20, so that the hook grooves 14 are positioned and coupled with the hook portions 25. Therefore, because the combination of the present invention is not achieved by axially sliding the inner frame 20 against the outer frame 10, a fast assembling effect is able to be provided in a wide construction area, facilitating a greater effect of positioning and assembling of the frame material.

Furthermore, during the outer frame 10 being combined with the inner frame 20, the two slope walls 24 on the outer side of the inner frame 20 enable the bevel 18 and the slope edge 131 of the outer frame 10 to smoothly move along the slope walls 24 during the tapping assembling process, facilitating a fast assembling effect between the outer frame 10 and the inner frame 20.

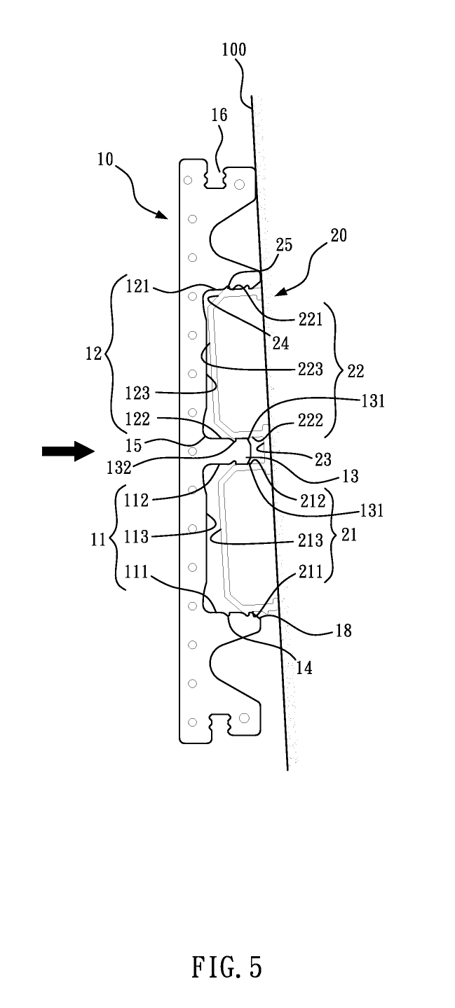

Referring to FIG. 5, when a surface-to-be-treated 100 is a wall surface which is not vertical or is inclined to the floor, the coupling structure between the hook grooves 14 of the outer frame 10 and the hook portions 25 of the inner frame 20 optionally varies, wherein only one hook portion 25 is coupled in one corresponding hook groove 14 of the inside wall 111, while two hook portions 25 are coupled with two corresponding hook grooves 14 of the other inside wall 121, such that the interval space between the outer frame 10 and the inner frame 20 is adjusted, whereby the outer side of the outer frame 10 remains vertical against the floor. When the amount of the hook grooves 14 and the corresponding hook portions 25 increase, the adjustable interval space is larger, facilitating the installation process upon an irregular surface-to-be-treated.

With the foregoing configuration, a greater installation possibility is provided. The combination between the outer frame 10 and the inner frame 20 substitutes the construction component of a single real wood unit or a single metal unit, providing the combination variety and solving the disadvantages of a real wood material consuming natural resource and of a metal material being aesthetically stiff and heat absorbing easily.

Referring to FIG. 6, with the foregoing configuration, the combination frame material 1 in accordance with the present invention is allowed to be applied on floors.

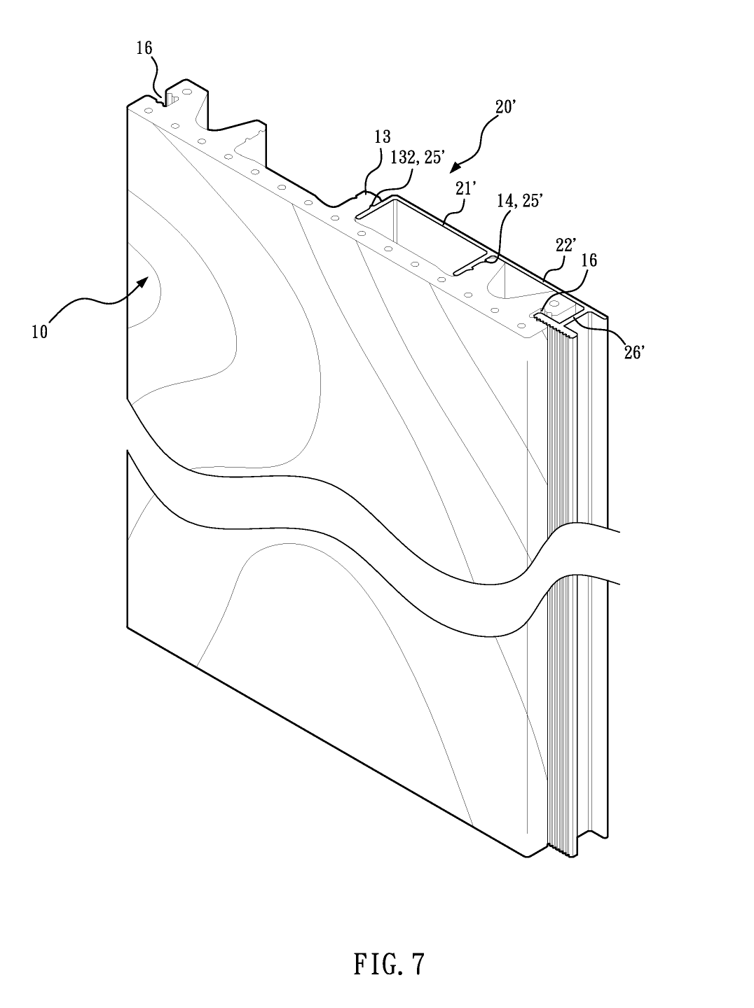

Referring to FIG. 7 illustrating another embodiment of the present invention, the inner frame 20′ is reversely combined with the outer frame 10. The outer side of the combining part 22′ of the inner frame 20′ has an I-shaped connect part 26′. As a result, the inner frame 20′ is allowed to be reversely combined with the outer frame 10 through the connect part 26′ of the combining part 22′ connected in the connect groove 16, and the hook portion 25′ of the combining part 21′ is coupled with the coupling groove 132 of the middle pillar 13. Therefore, an embodiment with a reverse application of the inner frame 20 against the outer frame 10 is provided, providing further applicability of the present invention.

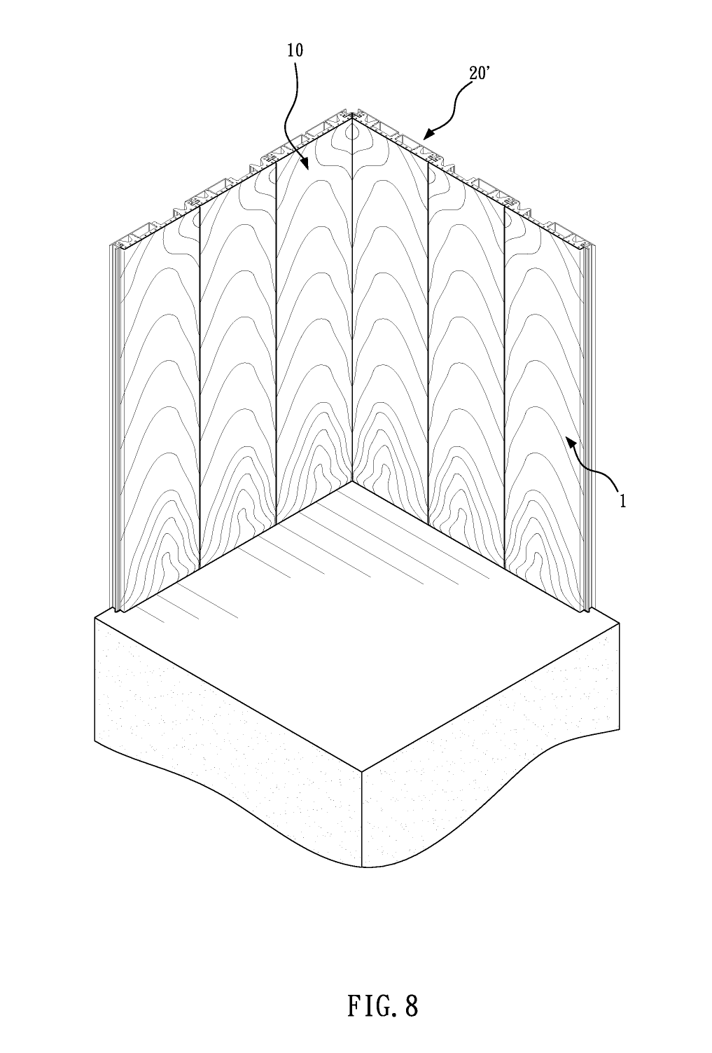

Referring to FIG. 8, with the foregoing configuration, the combination between the inner frame 20′ and the outer frame 10 is allowed to be applied on wall surfaces.

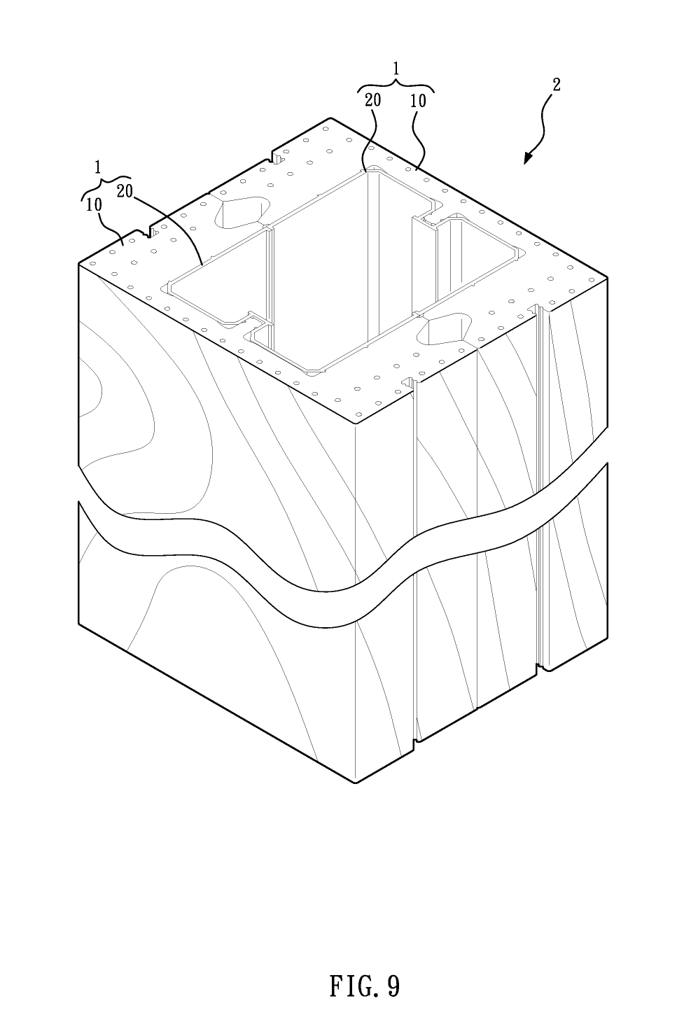

Referring to FIG. 9, two combination frame materials 1 in accordance with the present invention are allowed to be combined and fastened by use of two inner frames 20, with two outer frames 10 combined to the two inner frames 20 afterward, respectively, so as to form a square shape standing pillar 2, providing further applicability of the present invention.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A combination frame material, comprising:
an inner frame formed of an aluminum extrusion and axially provided with two parallel combining parts, a pillar groove disposed between the two combining parts and dividing the two combining parts, each of the combining parts having an outer wall, an inner wall, and a flat wall connected between the outer wall and the inner wall, the two inner walls disposed on two sides of an inner side of the pillar groove, a slope wall inclinedly disposed in an angle between the flat wall and the outer wall and between the flat wall and the inner wall, respectively, each of the outer walls longitudinally provided with plural hook portions, each of the hook portions extending along an axial direction of the inner frame; and
an outer frame formed of plastic-wood material and having an outer side and an inner side, the inner side having two combining grooves and a middle pillar disposed between the two combining grooves, the middle pillar dividing the two combining grooves, an inside wall of each combining groove opposite to the middle pillar having plural hook grooves, such that the outer frame is transversely combined with the inner frame, the middle pillar is inserted in the pillar groove, the two combining parts are combined in the two combining grooves, and the hook grooves are coupled with the hook portions.

2. The combination frame material of claim 1, wherein the slope wall is inclinedly disposed in an angle from 30 to 45 degrees against the flat wall.

3. The combination frame material of claim 1, wherein each hook portion is inclinedly disposed in an angle from 30 to 45 degrees toward an outer side of each outer wall.

4. The combination frame material of claim 1, wherein at least one of the hook portions on each outer wall neighbors one corresponding slope wall.

5. The combination frame material of claim 1, wherein an end part of each hook portion is formed in a circular shape, and an inner end of each hook groove is also formed in a circular shape.

6. The combination frame material of claim 1, wherein each inside wall of the outer frame opposite to the middle pillar is provided with a bevel.

7. The combination frame material of claim 6, wherein the length of the bevel is smaller than the length of the slope wall.

8. The combination frame material of claim 1, wherein two sides of an end part of the middle pillar is provided with a slope edge, respectively.

9. The combination frame material of claim 8, wherein the length of each slope edge is smaller than the length of each slope wall.

10. The combination frame material of claim 1, wherein the shape of the hook portion is identically matched with the shape of the hook groove.

11. The combination frame material of claim 1, wherein the length of the middle pillar is smaller than the length of the inside wall.

12. The combination frame material of claim 1, wherein the amount of the hook portions is matched with the amount of the hook grooves.

13. The combination frame material of claim 1, wherein each combining groove further has a bottom wall and two corner recesses disposed on two sides of the bottom wall, and the corner recesses correspondingly overlap the slope wall, respectively.

14. The combination frame material of claim 1, wherein the combining parts of the inner frame are formed in a hollow shape; also, the opening of the inner frame and the opening of the outer frame face the same direction.

15. The combination frame material of claim 1, wherein two sides of the outer frame are provided with a connect groove, respectively.
